(19) United States
(12) Patent Application Publication
(10) Pub. No.: US 2024/0116765 A1
(43) Pub. Date: Apr. 11, 2024

(54) SILICON OXIDE-BASED NEGATIVE ELECTRODE ACTIVE MATERIAL FOR SECONDARY BATTERY, METHOD OF PRODUCING SILICON OXIDE-BASED NEGATIVE ELECTRODE ACTIVE MATERIAL, AND NEGATIVE ELECTRODE FOR SECONDARY BATTERY INCLUDING SILICON OXIDE-BASED NEGATIVE ELECTRODE ACTIVE MATERIAL

(71) Applicants: SK ON CO., LTD., Seoul (KR); SK INNOVATION CO., LTD., Seoul (KR)

(72) Inventors: Eun Jun PARK, Daejeon (KR); Sang Hye SHIN, Daejeon (KR); Nak Won KIM, Daejeon (KR); Joon Hyung MOON, Daejeon (KR); Jung Hyun YUN, Daejeon (KR)

(21) Appl. No.: 18/481,753

(22) Filed: Oct. 5, 2023

(30) Foreign Application Priority Data
Oct. 6, 2022 (KR) 10-2022-0128147

(51) Int. Cl. C01B 33/187; H01M 10/052

(52) U.S. Cl. CPC C01B 33/187; H01M 10/052; C01P 2002/74; C01P 2002/82; C01P 2006/40

(57) ABSTRACT

Silicon oxide-based negative electrode active materials and negative electrodes for a secondary battery are disclosed. In an embodiment, a negative electrode active material for a secondary battery includes a silicon oxide particle including a metal silicate; and a hydrocarbon coating layer on the silicon oxide particle, wherein a peak Pa in a Fourier transform infrared (FT-IR) spectral analysis of the negative electrode active material is detected in a range from 2880 cm⁻¹ to 2950 cm⁻¹ and a peak Pb in a FT-IR spectral analysis of the negative electrode active material is detected in a range from 2800 cm⁻¹ to 2865 cm⁻¹.

### CROSS-REFERENCE TO RELATED APPLICATIONS

This patent document claims the priority and benefits of Korean Patent Application No. 10-2022-0128147, filed on Oct. 6, 2022, the disclosure of which is incorporated herein by reference in its entirety.

### TECHNICAL FIELD

The disclosed technology relates to a silicon oxide-based negative electrode active material for a secondary battery, a method of producing the silicon oxide-based negative electrode active material, and a negative electrode for a secondary battery including the silicon oxide-based negative electrode active material.

### BACKGROUND

Reducing carbon dioxide in the atmosphere is very important to reduce global warming. In an attempt to reduce carbon dioxide in the atmosphere, many countries are urging their citizens to shift to using electric vehicles and energy storage systems (ESS), and as a result there has been an increase in demand for energy storage devices such as lithium secondary batteries.

### SUMMARY

The disclosed technology can be implemented in some embodiments to address issues arising from gassing and a change in viscosity of a slurry over time, which may occur in a silicon oxide-based negative electrode material after performing a metal pre-doping process such as a pre-lithiation process on the silicon oxide-based negative electrode material in order to improve initial efficiency. The disclosed technology can be implemented in some embodiments to significantly improve slurry stability by maintaining the viscosity of a slurry over time even when the slurry is left for a long time.

The disclosed technology can be implemented in some embodiments to effectively remove residual metal in the negative electrode active material formed by the metal doping process and to decrease damage to the negative electrode active material.

In one general aspect, a negative electrode active material for a secondary battery includes: a silicon oxide particle including a metal silicate; and a hydrocarbon coating layer on the silicon oxide particle, wherein a peak Pa is detected in a range from 2880 cm⁻¹ to 2950 cm⁻¹ and a peak Pb is detected in a range from 2800 cm⁻¹ to 2865 cm⁻¹ in Fourier transform infrared (FT-IR) spectral analysis of the negative electrode active material. The peaks Pa and Pb may refer to a maximum absorbance peaks, respectively, derived from an aliphatic —CH₂ group in the wavenumber range.

The negative electrode active material for a secondary battery implemented based on an example embodiment may have a Sb/Sa value of 0.7 or less, the Sb/Sa being a ratio of a second peak area Sb in 2800 cm⁻¹ to 2865 cm⁻¹ to a first peak area Sa in 2880 cm⁻¹ to 2950 cm⁻¹ in the FT-IR spectral analysis. The first peak area Sa refers to an area value of the integral of the peak in a wavenumber ranging from 2880 cm⁻¹ to 2950 cm⁻¹, and the second peak area Sb refers to an area value of the integral of the peak in a wavenumber ranging from 2800 cm⁻¹ to 2865 cm⁻¹.

In an example embodiment, the Sb/Sa value may be 0.5 or less.

In an example embodiment, the first peak area Sa value may be 3.0 or less.

In an example embodiment, the second peak area Sb value may be 1.5 or less.

The negative electrode active material for a secondary battery implemented based on an example embodiment may further have peaks Pc1 and Pc2 detected in 1520 cm⁻¹ to 1600 cm⁻¹ in the FT-IR spectral analysis. The peaks Pc1 and Pc2 may refer to a maximum absorbance peaks, respectively, derived from a terminal carboxyl group of the oleic acid.

In an example embodiment, the metal silicate may include a metal silicate of any one of Li, Na, Mg, and K.

In an example embodiment, the metal silicate may include a lithium silicate represented by the following Chemical Formula 1:

LiₓSi_{y}O_{z} [Chemical Formula 1]
wherein 1≤x≤6, 1≤y≤4, and 0<z≤7.

In an example embodiment, the hydrocarbon coating layer may include a straight-chain hydrocarbon organic acid having 8 or more carbon atoms or a derivative thereof.

In an example embodiment, the straight-chain hydrocarbon organic acid may be a fatty acid.

In another general aspect, a method of producing a negative electrode active material for a secondary battery includes: a) forming a silicon oxide particle including a metal silicate; and b) immersing the silicon oxide particle in an organic acid solution to form a hydrocarbon coating layer on the silicon oxide particle. In this way, a negative electrode active material is formed.

In an example embodiment, the metal silicate of the operation (a) may include a metal silicate of any one of Li, Na, Mg, and K.

In an example embodiment, the organic acid of the operation (b) may include a straight-chain hydrocarbon organic acid having 8 or more carbon atoms.

In an example embodiment, the straight-chain hydrocarbon organic acid may be a fatty acid.

In an example embodiment, in the operation (b), the hydrocarbon coating layer may be formed by drying the organic acid-treated silicon oxide particle at 50 to 300° C.

In an example embodiment, the operation (b) may include: (b1) immersing the silicon oxide particle in an acid solution including an inorganic acid or an organic acid having 6 or fewer carbon atoms; and (b2) immersing the product of the operation (b1) in an organic acid solution to form a hydrocarbon coating layer.

In an example embodiment, a molar concentration of the acid solution of the operation (b1) may be 0.01 to 1.0 M.

In an example embodiment, the molar concentration of the organic acid solution of the operation (b2) may be 0.01 to 0.5 M.

In another general aspect, a negative electrode for a secondary battery includes: the negative electrode active material of the example embodiment described above.

The negative electrode implemented based on an example embodiment may further include graphite.

In still another general aspect, a secondary battery includes the negative electrode of the example embodiment described above.

Other features and aspects will be apparent from the following detailed description, the drawings, and the claims.

### BRIEF DESCRIPTION OF THE DRAWINGS

FIG. 1 shows an example FT-IR analytical spectrum of the negative electrode active material of Example 2, reference, and a comparative Example 1, and an oleic acid sample.

FIG. 2 shows an example FT-IR analytical spectrum of the negative electrode active material of Example 3, reference, and a comparative Example 2, and an oleic acid sample.

### DETAILED DESCRIPTION

Specific examples of features of the disclosed technology and associated advantages of the disclosed technology for negative electrode active materials for secondary batteries are disclosed in the following description of example embodiments. However, the disclosed technology is not limited to the example embodiments disclosed below, but will be implemented in various forms.

In some embodiments, when an element such as a layer, film, region, or substrate is “on” or “above” another element, the layer, film, region, or substrate can be directly disposed on the other element or the layer, film, region, or substrate can be disposed over the other element with one or more intervening elements therebetween.

In some embodiments, “D50” refers to a particle diameter with a cumulative volume of 50% when cumulated from the smallest particle in measurement of a particle size distribution by a laser scattering method. In an example embodiment, D50 may be obtained by collecting a sample for the material to be measured according to the standard of KS A ISO 13320-1 and measuring a particle size distribution using Mastersizer 3000 from Malvern Panalytical Ltd.

In some embodiments, a “core-shell structure” refers to a structure in which a core material at the center is surrounded by a material forming a shell.

In an example lithium secondary battery, a carbon (C)-based negative electrode material such as natural graphite and artificial graphite is used as an electrode material. However, the energy density of a battery that uses graphite as a negative electrode is low due to its low theoretical capacity (about 372 mAh/g). In order to address these issues, researchers have been developing new materials to increase the energy density of negative electrodes.

As an example, a silicon (Si)-based negative electrode material having a high theoretical capacity of about 3580 mAh/g can be used as an electrode material. However, its large volume expansion (˜400%) in the process for repeatedly charging and discharging can negatively affect the lifespan of a battery that includes the silicon-based negative electrode material.

As an example, a silicon oxide-based negative electrode material having a volume expansion rate lower than Si can be used as an electrode material. The silicon oxide-based negative electrode material can have a longer lifespan than the silicon-based negative electrode material, due to its low volume expansion rate. However, a battery that has the silicon oxide-based negative electrode material may not have a good initial coulombic efficiency (ICE) due to the formation of an irreversible phase at the beginning of operation.

In some implementations, the initial efficiency of a battery may be drastically improved by pre-doping a silicon oxide-based negative electrode material with a metal, such as pre-lithiation, but the pH is increased by a large amount of residual metal having high activity produced during the metal doping treatment, thereby deteriorating a binder in the production of an aqueous electrode and making electrode production difficult. In addition, residual lithium is continuously eluted in an aqueous slurry state and hydrogen gas is produced to cause a stability issue when the slurry is left for a long time. In addition, there can be changes in the viscosity of a stored slurry over time, increasing non-uniformity of the slurry and making uniform coating in electrode production difficult.

In order to remove the residual metal, a post-treatment technology using a high-concentration acid solution or a strong acid solution may be used. However, silicon oxides and various metal silicates included in a negative electrode active material may be etched together by the post-treatment technology, deteriorating the capacity and the initial efficiency of a battery. In addition, even if the residual metal is temporarily removed by a high-concentration acid solution or a strong acid solution, the pH is increased again by residual metal, which is continuously eluted when the slurry is left for a long time to cause a change in viscosity of the slurry over time, and thus, the physical properties of the slurry may still be deteriorated.

An example embodiment of the disclosed technology may provide a negative electrode active material for a secondary battery including: a silicon oxide particle including a metal silicate; and a hydrocarbon coating layer on the silicon oxide particle, wherein a peak Pa of Fourier transform infrared (FT-IR) spectral analysis of the negative electrode active material is detected in a range from 2880 cm⁻¹ to 2950 cm⁻¹ and a peak Pb of FT-IR spectral analysis of the negative electrode active material is detected in a range from 2800 cm⁻¹ to 2865 cm⁻¹.

The negative electrode active material of the example embodiment may include a silicon oxide particle including a metal silicate by pre-doping a silicon oxide particle having a low volume expansion rate in order to improve initial efficiency of a battery. In addition, in an example embodiment, a hydrocarbon coating layer having a specific composition may be provided to address issues associated with gassing and a change in viscosity of a slurry over time, which may occur in a silicon oxide-based negative electrode material.

The arrangement or structure of the hydrocarbon coating layer of the example embodiment is not particularly limited as long as the hydrocarbon coating layer is formed on at least a part or all of the silicon oxide particle. The negative electrode active material for a secondary battery of a specific example embodiment for preventing elution of residual metal in a silicon oxide particle to further increase slurry stability may include the silicon oxide particle as a core and the hydrocarbon coating layer as a shell, and specifically, may have a core-shell structure including a silicon oxide core; and a hydrocarbon shell, but is not limited thereto.

It is well known that a specific material composition of a negative electrode active material with silicon oxide particles including a metal silicate and being coated with a hydrocarbon coating layer can exhibit a unique optical spectral property using an optical absorption or emission measurement. Thus, different material compositions exhibit different unique optical spectral properties. For example, a material sample can be radiated with infrared probe light and the optical absorption can be measured by measuring the optical transmission through the material sample based on a Fourier transform infrared (FT-IR) spectral analysis. Specifically, Since the negative electrode active material for a secondary battery satisfying a certain Sb/Sa value range in the FT-IR spectral analysis may include a hydrocarbon coating layer that is more uniform and has a sufficient thickness, formed on the silicon oxide particle, elution of residual metal in the silicon oxide particle is better prevented, and thus it is possible to more significantly increase long-term slurry stability, and additionally it is possible to further suppress volume expansion of the silicon oxide particle during charge and discharge of a battery.

Accordingly, the negative electrode active material for a secondary battery of the example embodiment may include the hydrocarbon coating layer having a specific composition in which a peak Pa is detected in a range from 2880 cm⁻¹ to 2950 cm⁻¹ and a peak Pb is detected in a range from 2800 cm⁻¹ to 2865 cm⁻¹ in FT-IR spectral analysis by conducting optical absorption measurements of a negative electrode active material under IR radiation covering the spectral ranges from 2880 cm⁻¹ to 2950 cm⁻¹ and from 2800 cm⁻¹ to 2865 cm⁻¹. The peaks Pa and Pb may refer to a maximum absorbance peaks derived from an aliphatic —CH₂ group in the wavenumber range, respectively.

In an example embodiment, a negative electrode active material having a hydrocarbon coating layer having a specific composition, in which the Pa and Pb peaks are detected, can be formed on a silicon oxide particle. In an example embodiment, the hydrocarbon coating layer may be formed without damaging the silicon oxide particle and/or a metal silicate. In this way, elution of residual metal in the silicon oxide particle may be prevented, thereby significantly increasing long-term slurry stability, and additionally volume expansion of the silicon oxide particle during charge and discharge of a battery may be suppressed.

In an example embodiment, a Sb/Sa value of the negative electrode active material for a secondary battery may be more than 0, 0.1 or more, 0.2 or more, 0.3 or more and 0.7 or less, 0.6 or less, 0.5 or less, or between the numerical values, specifically more than 0 and 0.7 or less, more specifically for further improving long-term slurry stability, 0.1 to 0.6, and e.g., 0.2 to 0.5. Here, the Sb/Sa value is a ratio of a second peak area Sb in 2800 cm⁻¹ to 2865 cm⁻¹ to a first peak area Sa in 2880 cm⁻¹ to 2950 cm⁻¹ in FT-IR spectral analysis, but the disclosed technology is not limited thereto. In an example embodiment, the first peak area Sa refers to an area value of the integral of the peak in a wavenumber ranging from 2880 cm⁻¹ to 2950 cm⁻¹, and the second peak area Sb refers to an area value of the integral of the peak in a wavenumber ranging from 2800 cm⁻¹ to 2865 cm⁻¹.

Since the negative electrode active material for a secondary battery satisfying the Sb/Sa value range in the example embodiment may include a hydrocarbon coating layer that is more uniform and has a sufficient thickness, formed on the silicon oxide particle, elution of residual metal in the silicon oxide particle is better prevented, and thus it is possible to more significantly increase long-term slurry stability, and additionally it is possible to further suppress volume expansion of the silicon oxide particle during charge and discharge of a battery.

Though not particularly limited thereto, in an example embodiment, the first peak area Sa value may be more than 0 and 3.0 or less, 2.0 or less, 1.8 or less, 1.5 or less, 0.7 or less or between the numerical values, and specifically more than 0 and 3.0 or less or more than 0 and 2.0 or less. In order to secure a more uniform hydrocarbon coating layer in an example embodiment, the first peak area Sa value may be more than 0 and 1.8 or less. In an example embodiment in which the silicon oxide particle is pre-treated with a general acid solution and post-treated with a long-chain hydrocarbon organic acid solution to obtain a more uniform and stable hydrocarbon coating layer, the first peak area Sa value may be more than 0 and 1.5 or less or more than 0 and 0.7 or less.

In an example embodiment, by way of example only, the second peak area Sb value may be more than 0 and 1.5 or less, 1.2 or less, 1.0 or less, 0.5 or less or between the numerical values, and specifically more than 0 and 1.5 or less or more than 0 and 1.2 or less. In order to secure a more uniform hydrocarbon coating layer in an example embodiment, the second peak area Sb value may be more than 0 and 1.0 or less. In an example embodiment in which the silicon oxide particle is pre-treated with a general acid solution and post-treated with a long-chain hydrocarbon organic acid solution to obtain a more uniform and stable hydrocarbon coating layer, the second peak area Sb value may be more than 0 and 0.5 or less.

Hereinafter, the negative electrode active material for a secondary battery of the present example embodiment will be described in detail.

In an example embodiment, the silicon oxide particle may include a silicon oxide (SiOₓ (0<x≤2)); and one or two or more of Si, a Si-containing alloy, and a Si/C composite. The Si-containing alloy may be a Si-Q alloy, but is not limited thereto. Q is an element selected from the group consisting of alkali metals, alkaline earth metals, group 13 elements, group 14 elements other than Si, group 15 elements, group 16 elements, transition metals, rare earth elements, and combinations thereof. The element Q may be, for example, selected from the group consisting of Li, Mg, Na, K, Ca, Sr, Ba, Ra, Sc, Y, Ti, Zr, Hf, Rf, V, Nb, Ta, db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ge, P, As, Sb, Bi, S, Se, Te, Po, and combinations thereof, but is not limited thereto.

In an example embodiment, the metal silicate may be formed by a metal doping process, and may include a metal silicate of any one of Li, Na, Mg, and K. In an example embodiment, the metal silicate may include a lithium silicate. In an example embodiment, the lithium silicate may include a lithium silicate represented by the following Chemical Formula 1:

LiₓSi_{y}O_{z} [Chemical Formula 1]
wherein 1≤x≤6, 1≤y≤4, and 0<z≤7.

A non-limiting example of the lithium silicate may include Li₂SiO₃, Li₂Si₂O₅, Li₄SiO₄, or others.

In an example embodiment, the hydrocarbon coating layer may be formed by immersing the silicon oxide particle in an organic acid solution and then drying, but the means for providing the hydrocarbon coating layer is not limited as long as the peaks Pa and Pb are detected. Without particular limitations, when the hydrocarbon coating layer includes a long chain hydrocarbon organic acid having 8 or more carbon atoms or a derivative thereof, the layer has increased hydrophobicity, and may maintain a coating layer structure stably on the surface of the silicon oxide particle without being dissolved in an aqueous slurry phase, and thus, the hydrocarbon coating layer having the specific composition may be more effectively formed. In an example embodiment, the hydrocarbon coating layer may include a straight-chain hydrocarbon organic acid having 8 or more, 10 or more, 12 or more, 16 or more, 18 or more and 40 or fewer, 36 or fewer, 32 or fewer, 30 or fewer carbon atoms, or carbon atoms between the numerical values, or a derivative thereof, and specifically, a straight-chain hydrocarbon organic acid having 8 to 40, 10 to 36, 12 to 32, 16 to 30, or 18 to 30 carbon atoms or a derivative thereof, but is not limited thereto.

In an example embodiment, the straight-chain hydrocarbon organic acid may include at least one of a carboxyl group, a hydroxyl group, a sulfonic acid group, a phosphonic acid group, or combinations thereof, but is not limited thereto. In an example embodiment, the derivative of the straight-chain hydrocarbon organic acid may be a reacted product between the straight-chain hydrocarbon organic acid and the silicon oxide particle.

In an example embodiment, the straight-chain hydrocarbon organic acid may be a fatty acid, but is not limited thereto. A non-limiting example of the fatty acid may include oleic acid, palmitic acid, stearic acid, lauric acid, linoleic acid, arachidonic acid, or others, and these may be used alone or in combination.

In the FT-IR spectral analysis of the negative electrode active material for a secondary battery when the fatty acid is adopted as the straight-chain hydrocarbon organic acid as in some example embodiments, a peak derived from a terminal carboxylic group may be further detected. In the FT-IR spectral analysis of the negative electrode active material for a secondary battery implemented based on an example embodiment in which the fatty acid is adopted as the straight-chain hydrocarbon organic acid, peaks Pc1 and Pc2 may be further detected in 1520 cm⁻¹ to 1600 cm⁻¹.

In an example embodiment, an average particle diameter (D50) of the silicon oxide particles may be 1 m or more, 2 m or more, 3 m or more, 30 m or less, 25 m or less, 20 m or less, or between the numerical values, and specifically 1 to 30 m, 2 to 25 m, or 3 to 20 m, but is not limited thereto.

The means for providing or forming the negative electrode active material is not limited to what is discussed above. In some example embodiments, a negative electrode active material can be produced as will be discussed below.

In an example embodiment, a method of producing a negative electrode active material for a secondary battery may include: (a) forming a silicon oxide particle including a metal silicate; and (b) forming a hydrocarbon coating layer on the silicon oxide particle by immersing the silicon oxide particle in an organic acid solution.

In an example embodiment, the operation (a) discussed above may include (a1) forming a silicon oxide particle; and (a2) a metal doping process for doping the silicon oxide particle with a metal. By performing the operations (a1) and (a2), the silicon oxide particle may be doped with a metal to form the silicon oxide particle including a metal silicate, thereby improving the capacity properties and the initial efficiency of the silicon oxide-based negative electrode material.

In an example embodiment, the operation (a1) for forming a silicon oxide particle may include mixing Si powder and SiO₂ powder as a raw material powder at an appropriate mixing ratio and performing a heat treatment to form the silicon oxide particle. In an example embodiment, the heat treatment may be placing mixed powder of Si powder and SiO₂ powder in a furnace under an inert atmosphere, and performing a heat treatment at 500° C. or higher and lower than 1800° C., lower than 1500° C., lower than 900° C., lower than 800° C., 700° C. or lower, 650° C. or lower under reduced pressure, or at a temperature between the numerical values, and specifically, performing a heat treatment at 500° C. or higher and lower than 1800° C., 500° C. or higher and lower than 1500° C., 500° C. or higher and lower than 900° C., 500° C. or higher and lower than 800° C., 500 to 700° C., or 500 to 650° C., but is not limited thereto. A heat treatment time may be 1 hour or more, 2 hours or more and 12 hours or less, 8 hours or less, or between the numerical values, and specifically 1 to 12 hours or 2 to 8 hours, but is not limited thereto.

In an example embodiment, the operation (a2) for metal doping may be used to address some issues associated with forming an irreversible phase of a silicon oxide-based material during initial charge and discharge of a battery to deteriorate initial efficiency, and the means is not particularly limited as long as the silicon oxide particle is doped with the metal, but a non-limiting example of the process for doping the silicon oxide particle with a metal may include a heat treatment method of mixing the silicon oxide particle and a metal precursor and performing a heat treatment, an impregnation method of impregnating the silicon oxide particle in a solution including a metal salt as a metal precursor, a contact method of bringing a metal precursor and the silicon oxide particle into contact in a solution including an electrolyte solution, a deposition method of depositing metal steam as a metal precursor on the silicon oxide particle, or others.

In an example embodiment, the metal precursor of the operation (a2) for metal doping may include one or two or more selected from the group consisting of Li, Na, Mg, and K, and specifically, the metal precursor may include one or two or more of metal particles including one or two or more selected from the group consisting of Li, Na, Mg, and K; and metal hydrides, metal hydroxides, metal oxides, or metal carbides including one or two or more selected from the group consisting of Li, Na, Mg, and K. A specific example of the metal precursor may be a Li precursor including at least one selected from LiOH, Li, LiH, Li₂O, and Li₂CO₃, but is not limited thereto.

In an example embodiment, the operation (a2) for metal doping may be performed by a heat treatment method of mixing the silicon oxide particle and the metal precursor and performing a heat treatment. In an example embodiment, the operation (a) may include (a1) forming a silicon oxide particle; and (a2) a metal doping process for mixing the silicon oxide particle and the metal precursor and performing a heat treatment to dope the silicon oxide particle with a metal.

In an example embodiment of performing the operation (a2) for metal doping by the heat treatment method, the silicon oxide particle and the metal precursor may be mixed at a M/Si (metal/silicon) mole ratio of 0.3 or more, 0.4 or more, 0.5 or more and 1.2 or less, 1.0 or less, 0.8 or less or between the numerical values, and specifically may be mixed at the M/Si (metal/silicon) mole ratio of 0.3 to 1.2 or 0.4 to 1.0, and more specifically 0.5 to 0.8. In particular, when a Li precursor is used as the metal precursor, an optimal ratio between Li₂SiO₃ and Li₂Si₂O₅ may be found in the mole ratio range, and formation of c-Si and Li₄SiO₄ may be suppressed to significantly improve the electrochemical performance of a battery.

In an example embodiment where the operation (a2) for metal doping is performed by the heat treatment method, the heat treatment conditions may be, for example, heat treating at 500° C. or higher and lower than 700° C. for 1 to 12 hours under an inert atmosphere. When the heat treatment is performed at a temperature lower than 700° C., Si crystal growth may be suppressed to better secure amorphous or microcrystalline silicon oxide particles. In addition, when the heat treatment is performed at a temperature of 500° C. or higher, the crystal phase growth of the silicon oxide particles may be further suppressed while further increasing a metal doping effect.

As an example of the inert atmosphere, a known method in which the inside of a reaction unit is purged with an inert gas to create an inert atmosphere may be applied, and in some implementations, the inert gas may be selected from Ne, Ar, Kr, N₂, or others, alone or in combination, and specifically, Ar or N₂ may be used, but the disclosed technology is not limited thereto.

Subsequently, the product of the operation (a) is recovered and pulverized, thereby producing the silicon oxide particles including the metal silicate. As the pulverization process, a known pulverization method may be applied, but is not limited thereto.

In an example embodiment, the metal silicate of the operation (a) may include a metal silicate of any one of Li, Na, Mg, and K. In a specific example embodiment, the metal silicate may include a lithium silicate. In a more specific example embodiment, the lithium silicate may include a lithium silicate represented by the following Chemical Formula 1:

LiₓSi_{y}O_{z} [Chemical Formula 1]
wherein 1≤x≤6, 1≤y≤4, and 0<z≤7.

A non-limiting example of the lithium silicate may include Li₂SiO₃, Li₂Si₂O₅, Li₄SiO₄, or others.

In an example embodiment, the operation (b) for immersing the silicon oxide particle in an organic acid solution to form a hydrocarbon coating layer on the silicon oxide particle may be performed. In an example embodiment, residual metal in the silicon oxide particle is removed and damage to the silicon oxide particle and/or the metal silicate may be significantly decreased by treating the silicon oxide particle including the metal silicate which has undergone a metal pre-doping process with an organic acid, specifically a long-chain hydrocarbon organic acid solution, and the hydrocarbon coating layer is formed on the silicon oxide particle to prevent further elution of residual metal in the silicon oxide particle, thereby significantly decreasing slurry gas emission even when the slurry is left for a long time and significantly improving slurry stability. In addition, the hydrocarbon coating layer additionally has an effect of suppressing volume expansion of the silicon oxide particle during charge and discharge of a battery.

Without particular limitations, when the organic acid of the operation (b) is a long-chain hydrocarbon organic acid, the layer has increased hydrophobicity, and may maintain a coating layer structure stably on the surface of the silicon oxide particle without being dissolved in an aqueous slurry. In an example embodiment, the organic acid of the operation (b) may be a straight-chain hydrocarbon organic acid having 8 or more, 10 or more, 12 or more, 16 or more, 18 or more and 40 or fewer, 36 or fewer, 32 or fewer, 30 or fewer carbon atoms, or carbon atoms between the numerical values, in consideration of the solubility, and may be a straight-chain hydrocarbon organic acid having specifically, 8 to 40 or 10 to 36, more specifically, 12 to 32, 16 to 30, or 18 to 30 carbon atoms, but is not limited thereto.

In an example embodiment, the straight-chain hydrocarbon organic acid may include one of a carboxyl group, a hydroxyl group, a sulfonic acid group, a phosphoric acid group, and combinations thereof, but is not limited thereto.

In an example embodiment, the straight-chain hydrocarbon organic acid may include a fatty acid, but is not limited thereto. A non-limiting example of the fatty acid may include oleic acid, palmitic acid, stearic acid, lauric acid, linoleic acid, arachidonic acid, or others, and these may be used alone or in combination.

The composition of the organic acid solution of the operation (b) is not limited as long as the organic acid solution includes the organic acid of the example embodiment described above, and various components may be selectively further included. In an example embodiment, the organic acid solution of the operation (b) may include the organic acid alone or in combination, but is not limited thereto.

In some implementations, the molar concentration of the organic acid solution of the operation (b) may be at a certain level or higher for better removing the residual metal in the silicon oxide particle and providing the hydrocarbon coating layer, but when the molar concentration is excessive, the capacity of the negative electrode active material may be rather deteriorated, and thus, the capacity properties may be better maintained at the molar concentration of a certain level or lower. In an example embodiment, the molar concentration of the organic acid solution of the operation (b) may be 0.01 M or more and 0.05 M or more, 0.1 M or more and 0.5 M or less, 0.4 M or less, 0.3 M or less or between the numerical values, and specifically, 0.01 to 0.5 M, 0.05 to 0.4 M, or 0.1 to 0.3 M, but is not limited thereto.

The solvent of the organic acid solution of the operation (b) may be any solvent known in the art without limitation as long as the organic acid is dissolved in the solvent, but for example, may be water, alcohol, tetrahydrofuran (THF), dimethylformamide (DMF), or others.

In an example embodiment, the hydrocarbon coating layer in the operation (b) may be formed by drying the organic acid-treated silicon oxide particle. When a drying temperature is excessively high, the organic acid component forming the hydrocarbon coating layer may be thermally decomposed, which leads to damaged durability of the hydrocarbon coating layer, and thus, the effect to be desired in the disclosed technology may not be secured. However, the drying temperature is excessively low, thermal energy may not be sufficient for strengthening a binding force between the silicon oxide component forming the particle and the organic acid component in the hydrocarbon coating layer. Taking this into consideration, in an example embodiment, the drying temperature may be 50° C. or higher, 80° C. or higher, 100° C. or higher, 120° C. or higher, 300° C. or lower, 250° C. or lower, 200° C. or lower, 180° C. or lower, or between the numerical values, and specifically, may be 50 to 300° C., 80 to 250° C., 100 to 200° C., or 120 to 180° C., but is not limited thereto.

In some implementations, unlike forming the hydrocarbon coating layer with the organic acid discussed above, when a method of adding the organic acid with the negative electrode active material in the production of the negative electrode slurry to neutralize a pH rise by residual metal is adopted, residual metal which is continuously eluted in the production of the negative electrode slurry may be neutralized in a short time, but when the negative electrode slurry is left for a long time, the residual metal is continuously eluted to increase the pH again, resulting in a decrease in viscosity of the negative electrode slurry. In addition, when the negative electrode active material component or the composition of the negative electrode slurry is changed, the amount of the organic acid added should be changed together, and when the amount of the organic acid added is increased, it may act as impurities in the negative electrode slurry to cause problems such as deterioration of capacity or initial efficiency or deterioration of life characteristics.

However, when the hydrocarbon coating layer is formed on the silicon oxide particle based on an example embodiment of the disclosed technology, the elution of the residual metal in the production of an aqueous negative electrode slurry may be suppressed, and thus, the residual metal is not eluted again even when leaving the negative electrode slurry for a long time to significantly improve slurry stability, and the composition of the negative electrode slurry may be freely changed without particular limitations.

In a specific example embodiment, when the silicon oxide particle is optionally pre-treated with a general acid solution in order to remove residual metal in the silicon oxide particle before forming the hydrocarbon coating layer, and when the hydrocarbon coating layer is formed, slurry stability, capacity properties, and initial efficiency may be further improved.

In an example embodiment of further removing the residual metal in the silicon oxide particle and forming the hydrocarbon coating layer on the silicon oxide particle from which the residual metal has been better removed to further improve slurry stability, the operation (b) may include (b1) immersing the silicon oxide particle in an acid solution including an inorganic acid or an organic acid having 6 or fewer carbon atoms; and (b2) immersing the resulting product of the operation (b1) in an organic acid solution to form a hydrocarbon coating layer, but is not limited thereto.

In an example embodiment, in order to further remove the residual metal in the silicon oxide particle before forming the hydrocarbon coating layer, the operation (b1) of immersing the silicon oxide particle in an inorganic acid or an organic acid having 6 or fewer carbon atoms may be further performed. In the example embodiment, the acid solution may be a solution including an inorganic acid or an organic acid having 6 or fewer carbon atoms alone or in combination.

In an example embodiment, the inorganic acid may include hydrochloric acid (HCl), perchloric acid (HClO₄), hypochlorous acid (HClO), sulfuric acid (H₂SO₄), nitric acid (HNO₃), phosphoric acid (H₃PO₄), hydrofluoric acid (HF), and a combination thereof, but is not limited thereto.

In an example embodiment, the organic acid having 6 or fewer carbon atoms may include formic acid, butyric acid, acetic acid, lactic acid, tartaric acid, malic acid, propionic acid, citric acid, and a combination thereof, but is not limited thereto.

The residual metal in the silicon oxide particle may be better removed when the molar concentration of the acid solution of the operation (b1) is at a certain level or higher, but when the molar concentration is excessive, the silicon oxide particle and/or the metal silicate is/are damaged to rather deteriorate the capacity properties or the initial efficiency, and thus, in some implementations, the molar concentration may be at a certain level or lower to secure excellent capacity properties and initial efficiency. In an example embodiment, the molar concentration of the acid solution of the operation (b1) may be 0.01 M or more, 0.05 M or more, 0.1 M or more, 1.0 M or less, 0.8 M or less, 0.6 M or less or between the numerical values, and specifically, may be 0.01 to 1.0 M, 0.05 to 0.8 M, or 0.1 to 0.6 M, but is not limited thereto.

The operation (b2) may include immersing the resultant of the operation (b1), that is, the silicon oxide particle from which the residual metal has been removed in an organic acid solution to form a hydrocarbon coating layer. By performing the operation (b2) subsequently, the residual metal in the silicon oxide particle formed by the metal doping process may be further removed to avoid damaging the silicon oxide particle and/or the metal silicate, and the hydrocarbon coating layer is formed on the silicon oxide particle from which the residual metal has been removed to prevent further elution of the residual metal in the silicon oxide particle to further increase slurry stability, and the hydrocarbon coating layer formed on the silicon oxide particle may suppress the volume expansion of the silicon oxide particle. In some implementations, the organic acid of the operation (b2) described above can be used to obtain a stable hydrocarbon coating layer.

In some implementations, the molar concentration of the organic acid solution of the operation (b2) may be at a certain level or higher to more effectively remove the residual metal in the silicon oxide particle and to more effectively form the hydrocarbon coating layer, but when the molar concentration is excessive, the capacity of the negative electrode active material may be rather deteriorated, and thus, the capacity properties may be better maintained at the molar concentration of a certain level or lower. In an example embodiment, the molar concentration of the organic acid solution of the operation (b2) may be 0.01 M or more and 0.05 M or more, 0.1 M or more and 0.5 M or less, 0.4 M or less, 0.3 M or less or between the numerical values, and specifically, 0.01 to 0.5 M, 0.05 to 0.4 M, or 0.1 to 0.3 M, but is not limited thereto.

The solvent of the acid solution of the operation (b1) and the organic solution of the operation (b2) may be any solvent known in the art without limitation as long as the acid component is dissolved in the solvent, but for example, may be water, alcohol, tetrahydrofuran (THF), dimethylformamide (DMF), or others.

In an example embodiment, the hydrocarbon coating layer in the operation (b2) may be formed by drying the organic acid-treated silicon oxide particle. When a drying temperature is excessively high, the organic acid component forming the hydrocarbon coating layer may be thermally decomposed, which leads to damaged durability of the hydrocarbon coating layer, and thus, the effect to be desired in the disclosed technology may not be secured. However, the drying temperature is excessively low, thermal energy may not be sufficient for strengthening a binding force between the silicon oxide component forming the particle and the organic acid component in the hydrocarbon coating layer. Taking this into consideration, in an example embodiment, the drying temperature may be 50° C. or higher, 80° C. or higher, 100° C. or higher, 120° C. or higher, 300° C. or lower, 250° C. or lower, 200° C. or lower, 180° C. or lower, or between the numerical values, and specifically, may be 50 to 300° C., 80 to 250° C., 100 to 200° C., or 120 to 180° C., but is not limited thereto.

In an example embodiment, a negative electrode for a secondary battery including the negative electrode active material described above may be provided. In an example embodiment, the negative electrode may be produced by forming a negative electrode slurry including the negative electrode active material of the example embodiment described above, a binder, a conductive material, or others, and then applying the prepared negative electrode slurry on a current collector, drying and rolling, but is not limited thereto. As the binder, the conductive material, and the current collector, any materials that have properties required for the binder, the conductive material, and the current collector, respectively, may be used.

In an example embodiment, the negative electrode may optionally further include graphite. The graphite may be natural graphite or artificial graphite, but is not particularly limited.

In an example embodiment, the composition of the negative electrode is not particularly limited as long as the negative electrode includes the negative electrode active material of the example embodiment described above, but In an example, the negative electrode may include more than 0 wt % and 40 wt % or less of the negative electrode active material of the example embodiment described above and 50 wt % or more of graphite, based on the total weight of the solid content, and may optionally further include 1.0 wt % or less of the conductive material and 10.0 wt % or less of the binder. A non-limiting example of the conductive material may include single wall-CNT (SW-CNT), multi wall-CNT (MW-CNT), thin wall-CNT (TW-CNT), or others. A non-limiting example of the binder may include a carboxyl methyl cellulose (CMC) binder, a styrene-butadiene rubber (SBR) binder, or others.

In an example embodiment, a secondary battery including the negative electrode of the example embodiment described above, a positive electrode, a separator formed between the negative electrode and the positive electrode, and an electrolyte solution may be provided.

The positive electrode may include, for example, a current collector and a positive electrode active material layer formed by applying a positive electrode slurry including a positive electrode active material on the current collector.

The current collector may be the same as the current collector of the negative electrode described above, or may include any materials that have properties required for current collectors.

The positive electrode active material layer includes a positive electrode active material, and optionally, may further include a binder and a conductive material. The positive electrode active material may include any materials that have properties required for positive electrode active materials. In one example, the positive electrode active material may include a composite oxide of a metal selected from cobalt, manganese, nickel, and a combination thereof with lithium.

The binder and the conductive material may include, for example, the negative electrode binder and the negative electrode conductive material described above, or any materials that have properties required for the negative electrode binder and the negative electrode can be used.

The separator may include any material that has properties required for separators. In an example, the separator may include at least one of glass fiber, polyester, polyethylene, or polypropylene, polytetrafluoroethylene, or a combination thereof, and/or in a non-woven fabric or a woven-fabric form. In another example, the separator may include a polyolefin-based polymer such as polyethylene and polypropylene, a separator coated with a composition including a ceramic component or a polymer material for securing heat resistance or mechanical strength, or a single layer or multi-layer separator.

The electrolyte solution may include, for example, an organic solvent and a lithium salt, but is not limited thereto.

The organic solvent may be, for example, a carbonate-based, ester-based, ether-based, ketone-based, alcohol-based, or aprotic solvent alone or in combination of two or more, and when it is used in combination of two or more, a mixing ratio may be properly adjusted depending on the battery performance to be desired, but is not limited thereto.

The lithium salt may include, for example, LiPF₆, LiBF₄, LiSbF₆, LiAsF₆, LiN(SO₃C₂F₅)₂, LiN(CF₃SO₂)₂, LiC₄F₉SO₃, LiClO₄, LiAlO₂, LiAlCl₄, LiN(CₓF₂ₓ₊₁SO₂)(C_{y}F_{2y+1}SO₂) (x and y are natural numbers), LiCl, LiI, LiB(C₂O₄)₂, or a combination thereof, but is not limited thereto.

A concentration of the lithium salt may be, for example, 0.1 to 2.0 M, but is not limited thereto.

The secondary battery in an example embodiment for providing the secondary battery of the example embodiment may be produced by laminating the negative electrode, the separator, and the positive electrode in this order to form an electrode assembly, placing the produced electrode assembly in a cylindrical battery case or an angled battery case, and then injecting an electrolyte solution. In another example embodiment, the secondary battery may be produced by laminating the electrode assembly, impregnating the assembly in the electrolyte solution, placing the resultant product in a battery case, and sealing the case. However, the method of producing a secondary battery is not limited to the examples described above.

As the battery case, those commonly used in the art may be adopted and there is no limitation in appearance depending on the battery use, and for example, a cylindrical shape, an angled shape, a pouch shape, a coin shape, or others using a can may be used.

The secondary battery implemented based on an example embodiment may be used in a battery cell that is used as an energy storage device or a power supply of a device, and may also be used as a unit cell in a medium or large battery module including a plurality of battery cells. Examples of the medium or large battery module may include an electric automobile, a hybrid electric automobile, a plug-in hybrid electric automobile, a system for power storage, or others. However, the use of the secondary battery is not limited to the examples described above.

Hereinafter, the preferred examples and the comparative examples of the disclosed technology will be described. However, the following examples are only preferred examples of the disclosed technology, and the disclosed technology is not limited thereto.

Hereinafter, the measurement and evaluation methods of physical properties will be described first.

Slurry Gas Emission

Bubbles of a slurry were removed as much as possible, the slurry was added to a sealable cylindrical container, and pressed, sealed, and waited for 1 day or 4 days, and the volume increased of the cylindrical container to the weight of the slurry added was measured to derive a slurry gas emission (ml/g).

Discharge Capacity, Initial Efficiency

A (half) battery was charged at a constant current at room temperature (25° C.) until the voltage reached 0.01 V (vs. Li/Li⁺) at a current of 0.1 C rate, and then was charged with a constant voltage by cut-off at a current of 0.01 C rate while maintaining 0.01 V in a constant voltage mode. The battery was discharged with a constant current of 0.1 C rate until the voltage reached 1.5 V (vs. Li/Li⁺) to measure the (initial) discharge capacity and the initial efficiency.

In the case of a negative electrode produced by mixing the silicon oxide-based negative electrode active material and graphite together for evaluating the discharge capacity and the initial efficiency of the silicon oxide-based negative electrode active material of the disclosed technology, evaluation was performed by assuming a negative electrode including the silicon oxide-based negative electrode active material alone at the same content as the mixed content of the silicon oxide-based negative electrode active material and graphite, with the contribution of discharge capacity and initial efficiency contributed by graphite being excluded to calibrate the discharge capacity and the initial efficiency.

### EXAMPLES

### Examples 1 and 2

(Negative Electrode Active Material)

Operation (a)

A raw material in which a silicon metal and silicon dioxide were mixed was introduced to a reaction furnace at 600° C. and evaporated in the atmosphere of a vacuum degree of 10 Pa to obtain a product, which was deposited on a suction plate and sufficiently cooled, and then a deposit was taken out and pulverized with a ball mill to form silicon oxide particles. Continuously, a particle diameter of the silicon oxide particle was adjusted by classification. An average particle diameter (D50) of the silicon oxide particle was 8 m.

The silicon oxide particles produced and LiH powder as a metal precursor were mixed at a Li/Si mole ratio of 0.3 to 1.2 to form mixed powder, and the mixed powder was filtered using a sieve of 25 to 500 m and heat-treated in a furnace under a nitrogen gas atmosphere at 600° C. for 1 to 12 hours to dope the silicon oxide particle with lithium metal. Subsequently, the heat-treated powder was recovered and then pulverized to produce silicon oxide particles including lithium silicate (such as Li₂Si₂O₅ and Li₂SiO₃).

Operation (b)

The silicon oxide particles produced in the operation (a) were immersed in the organic acid solution listed in the following Table 1, filtered, and dried under vacuum at 150° C. to produce a negative electrode active material having a hydrocarbon coating layer formed on the silicon oxide particle.

(Negative Electrode Slurry, Negative Electrode)

5 to 30 wt % of the negative electrode active material produced, 66 to 92 wt % of artificial graphite, 0.05 to 0.3 wt % of single wall-CNT (SW-CNT), 1.0 to 2.0 wt % of a carboxylmethyl cellulose (CMC) binder, and 1.0 to 3.0 wt % of a styrene-butadiene rubber (SBR) binder, based on the total weight of the solid content, were mixed in distilled water to form a negative electrode slurry. The negative electrode slurry was applied on a Cu foil current collector, dried, and rolled to produce a negative electrode having a negative electrode active material layer formed on the current collector by a common process.

(Half Battery)

The produced negative electrode and a lithium metal as a counter electrode were used, a PE separator was interposed between the negative electrode and the counter electrode, an electrolyte solution was injected thereto, and a coin cell (CR2016) was assembled. The assembled coin cell was paused at room temperature for 3 to 24 hours to produce a half battery. At this time, the electrolyte solution was obtained by mixing 1.0 M LiPF₆ as a lithium salt with an organic solvent (EC:EMC=30:70 vol %) and mixing 10 vol % of fluoroethylene carbonate (FEC) as an electrolyte additive.

### Examples 3 to 10

In performing the operation (b), the silicon oxide particles produced in the operation (a) were immersed in the acid solution listed in the following Table 1 and then filtered. Thereafter, the silicon oxide particles were immersed in the organic acid solution listed in the following Table 1, filtered, and dried under vacuum at 150° C. to produce a negative electrode active material having a hydrocarbon coating layer formed on the silicon oxide particle. A negative electrode active material, a negative electrode slurry, a negative electrode, and a half battery were produced under the same conditions as in Example 1 except the above production conditions.

### REFERENCE

A negative electrode active material, a negative electrode slurry, a negative electrode, and a half battery were produced under the same conditions as in Example 1 except that the operation (b) was not performed.

### Comparative Examples 1 to 5

A negative electrode active material, a negative electrode slurry, a negative electrode, and a half battery were produced under the same conditions as in Example 1 except that, in performing the operation (b), the silicon oxide particles produced by the operation (a) were immersed in the acid solution listed in the following Table 1, filtered, and dried at room temperature for 24 hours to produce a final negative electrode active material.

### Evaluation Example 1: Evaluation of Slurry Stability, Discharge Capacity, and Initial Efficiency

TABLE 1

| | | | | | Slurry gas | | | |
|---|---|---|---|---|---|---|---|---|
| | Acid solution | | Organic acid solution | | emission [ml/g] | | Discharge | Initial |
| | Type of | Concentration | Type of | Concentration | After | After | capacity | efficiency |
| | acid | [M] | acid | [M] | 1 day | 4 days | [mAh/g] | [%] |
| Example 1 | — | — | Oleic acid | 0.05 | 0.2 | 0.5 | 1288 | 88.6 |
| Example 2 | — | — | Oleic acid | 0.15 | 0.1 | 0.2 | 1312 | 88.2 |
| Example 3 | Citric acid | 0.19 | Oleic acid | 0.15 | 0.0 | 0.0 | 1307 | 91.7 |
| Example 4 | Citric acid | 0.24 | Oleic acid | 0.15 | 0.0 | 0.0 | 1320 | 88.9 |
| Example 5 | Acetic acid | 0.24 | Oleic acid | 0.15 | 0.0 | 0.0 | 1346 | 89.5 |
| Example 6 | Citric acid | 0.48 | Lauric acid | 0.15 | 0.04 | 0.05 | 1351 | 90.6 |
| Example 7 | Ammonium | 0.38 | Lauric acid | 0.15 | 0.12 | 0.3 | 1297 | 88.4 |
| | citrate | | | | | | | |
| Example 8 | Ammonium | 0.57 | Lauric acid | 0.15 | 0.14 | 0.2 | 1304 | 89.1 |
| | sulfate | | | | | | | |
| Example 9 | Citric acid | 0.24 | Ammonium | 0.15 | 0.00 | 0.39 | 1311 | 88.0 |
| | | | lauryl sulfate | | | | | |
| Example 10 | Citric acid | 0.24 | Oleyl | 0.15 | 0.00 | 0.44 | 1304 | 88.8 |
| | | | phosphate | | | | | |
| ref. | — | — | — | — | ≥1.6 | ≥1.6 | 1150 | 81.1 |
| Comparative | Citric acid | 0.19 | — | — | 0.8 | ≥1.6 | 1294 | 84.4 |
| Example 1 | | | | | | | | |
| Comparative | Acetic acid | 0.19 | — | — | 0.2 | ≥1.6 | 1356 | 87.4 |
| Example 2 | | | | | | | | |
| Comparative | Citric acid | 0.05 | — | — | ≥1.6 | ≥1.6 | 1194 | 83.1 |
| Example 3 | | | | | | | | |
| Comparative | Citric acid | 0.05 | — | — | 1.2 | ≥1.6 | 1285 | 84.7 |
| Example 4 | | | | | | | | |
| | Acetic acid | 0.05 | | | | | | |
| Comparative | Citric acid | 0.48 | — | — | 0.68 | ≥1.6 | 1312 | 85.2 |
| Example 5 | | | | | | | | |

Referring to the results of Table 1, in Examples 1 to 10, as a result of removing residual metal from the silicon oxide particles by the organic acid (oleic acid, lauric acid, ammonium lauryl sulfate, oleyl phosphate, or others) on the silicon oxide particles and as a result of forming the hydrocarbon coating layer, the slurry gas emission was significantly decreased, and in particular, the elution of the residual metal was prevented even when the negative electrode slurry was left for a long time, and thus, the slurry gas emission was significantly low. From the results, it was confirmed that significantly excellent slurry stability was secured as compared with ref which did not undergo operation (b). In addition, simultaneously, since Examples 1 to 10 had excellent discharge capacity and initial efficiency as compared with ref., it was confirmed that the residual metal was well removed and the elution of the residual metal was suppressed while decreasing damage to the silicon oxide particle and/or the metal silicate.

Among Examples 1 to 10, in particular, in Examples 3 to 10, in order to more effectively remove the residual metal in the silicon oxide particles, a process for immersing the silicon oxide particles in an acid solution and filtering was first performed, and the residual metal was removed again with the organic acid (oleic acid, lauric acid, ammonium lauryl sulfate, oleyl phosphate, or others) to form the hydrocarbon coating layer on the silicon oxide particle. As a result, in Examples 3 to 10, it was confirmed that the hydrocarbon coating layer was formed on the silicon oxide particle from which the residual metal was better removed and the slurry stability was better and the discharge capacity and the initial efficiency were also better than those of Examples 1 and 2.

However, in Comparative Examples 1 to 5, the residual metal was removed by an acid solution without forming the hydrocarbon coating layer, and the results that the slurry gas emission was less and the discharge capacity and the initial efficiency were improved to some extent when left for a short time as compared with ref were shown. However, in Comparative Examples 1 to 5, as a result of not forming the hydrocarbon coating layer, the slurry gas emission was excessively caused by the residual metal which was constantly eluted when the negative electrode slurry was left for a long time, and thus, the slurry stability to be desired in the disclosed technology was not able to be secured.

Specifically, in Comparative Examples 1, 2, and 5, as a result of removing the residual metal in the silicon oxide particles by a high-concentration acid solution as compared with Comparative Examples 3 and 4, the slurry gas emission was low after 1 day, but after leaving for a long time of 4 days, a large amount of the slurry gas was produced so that slurry stability was poor and the discharge capacity and the initial efficiency were deteriorated, and thus, electrochemical properties were also poor.

In Comparative Examples 3 and 4, as a result of removing the residual metal in the silicon oxide particle by a low-concentration acid solution as compared with Comparative Examples 1, 2, and 5, gassing immediately started, so that slurry stability was poor and the discharge capacity and the initial efficiency were deteriorated, and thus, electrochemical properties were also poor.

### Evaluation Example 2: Analysis of Composition of Hydrocarbon Coating Layer

In order to analyze the composition of the hydrocarbon coating layer, the FT-IR analysis of the negative electrode active material was performed, and the FT-IR analysis conditions were as follows:
Base-line region: 2791 cm⁻¹ to 2970 cm⁻¹
Peak region
: CH₂ 2880 cm⁻¹ to 2950 cm⁻¹
: CH₂ 2800 cm⁻¹ to 2865 cm⁻¹

Equipment Information
Maker: Thermo Fisher
Model: Nicolet 6700
Detector: DTGS KBr
ATR mode (Diamond crystal)

Measurement Conditions
Measurement range: 4000 cm⁻¹ to 650 cm⁻¹
Resolution: 8 cm⁻¹
Number of measurements per analysis sample: 32 scans

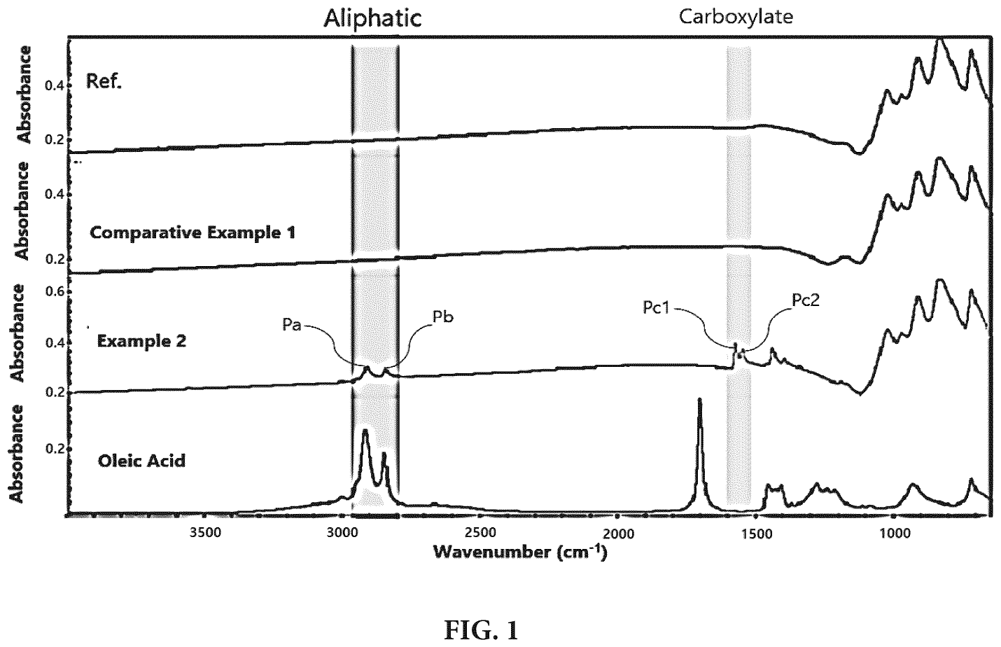

The results of the FT-IR analytical spectrum of the negative electrode active material of Example 2, ref, and Comparative Example 1, and oleic acid samples are shown in FIG. 1. Referring to FIG. 1, in Example 2 of the present example embodiment, a hydrocarbon coating layer in which peaks Pa and Pb derived from oleic acid were detected in 2880 cm⁻¹ to 2950 cm⁻¹ and in 2800 cm⁻¹ to 2865 cm⁻¹, respectively, was confirmed, but in ref and Comparative Example 1, the peaks Pa and Pb were not detected, and thus, it was confirmed that the hydrocarbon coating layer to be desired in the disclosed technology was not formed.

In addition, referring to FIG. 1, in Example 2, the hydrocarbon coating layer was formed well and peaks Pc1 and Pc2 derived from a terminal carboxyl group of the oleic acid were further detected in 1520 cm⁻¹ to 1600 cm⁻¹, but in Comparative Example 1, the hydrocarbon coating layer was not formed and the peaks Pc1 and Pc2 derived from the carboxyl group of citric acid were not detected.

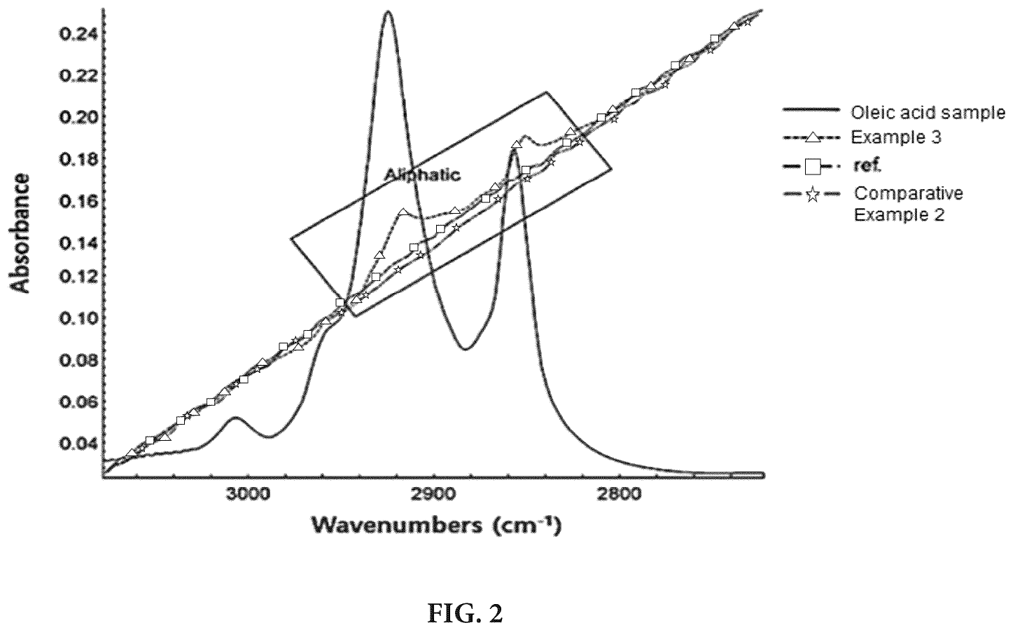

In order to confirm the peaks Pa and Pb precisely, FT-IR analysis of the negative electrode active material, oleic acid samples of Example 3, ref, and Comparative Example 2 was performed in 2700 cm⁻¹ to 3100 cm⁻¹ which is a narrower wave number range. The results are shown in FIG. 2. Referring to FIG. 2, in Example 3 of the present example embodiment, a hydrocarbon coating layer in which peaks Pa and Pb derived from oleic acid were detected in 2880 cm⁻¹ to 2950 cm⁻¹ and in 2800 cm⁻¹ to 2865 cm⁻¹, respectively, was confirmed, but in ref and Comparative Example 2, the peaks Pa and Pb were not detected, and thus, it was confirmed that the hydrocarbon coating layer to be desired in the disclosed technology was not formed.

In Examples 1 to 10, the peaks Pa and Pb were both detected as in Examples 2 and 3, and the peak areas of the Examples 1 to 10 in which the peaks Pa and Pb were detected were analyzed and the results are shown in the following Table 2:

TABLE 2

| | Peak area | | |
|---|---|---|---|
| | Sa | Sb | Sb/Sa |
| Example 1 | 0.949 | 0.511 | 0.538 |
| Example 2 | 1.673 | 0.868 | 0.519 |
| Example 3 | 0.072 | 0.035 | 0.486 |
| Example 4 | 0.065 | 0.029 | 0.446 |
| Example 5 | 0.145 | 0.064 | 0.441 |
| Example 6 | 0.169 | 0.068 | 0.402 |
| Example 7 | 0.684 | 0.472 | 0.690 |
| Example 8 | 0.590 | 0.337 | 0.571 |
| Example 9 | 0.359 | 0.133 | 0.370 |
| Example 10 | 0.292 | 0.092 | 0.315 |
| Oleic acid | 7.282 | 3.082 | 0.423 |
| sample | | | |

The first peak area Sa refers to an area value of the integral of the peak in a wave number from 2880 cm⁻¹ to 2950 cm⁻¹, and the second peak area Sb refers to an area value of the integral of the peak in a wave number from 2800 cm⁻¹ to 2865 cm⁻¹.

Referring to the results of Table 2, when the FT-IR spectral analysis was performed, the negative electrode active material of Examples 1 to 10 had a Sb/Sa ratio of 0.7 or less, and it was confirmed that a more uniform hydrocarbon coating layer having a sufficient thickness was formed on the silicon oxide particle to better prevent the elution of the residual metal in the silicon oxide particle and more significantly increase long-term slurry stability.

In Examples 1 and 2 which were treated with the long-chain hydrocarbon organic acid solution alone, the slurry gas emission was suppressed to some extent, but the slurry stability was relatively poor as compared with Examples 3 to 10 in which the silicon oxide particles were pre-treated with a general acid solution and post-treated with the long-chain hydrocarbon organic acid solution. From the results of Table 2, Examples 1 and 2 had a Sa value of 0.949 and 1.673, respectively, but Examples 3 to 10 had a Sa value of 0.7 or less, and thus, it was confirmed that a more uniform and stable hydrocarbon coating layer was obtained. In addition, Examples 1 and 2 had a Sb value of 0.511 and 0.868, respectively, but Examples 3 to 10 had a Sb value of 0.5 or less, and thus, it was confirmed that a more uniform and stable hydrocarbon coating layer was obtained.

In an example embodiment, a negative electrode active material having a hydrocarbon coating layer having a specific composition may be formed on a silicon oxide particle, and the hydrocarbon coating layer may be formed without damage to the silicon oxide particle and/or a metal silicate, and thus the slurry stability can be improved by preventing elution of residual metal in the silicon oxide particle. In one example, slurry gas emission may be significantly decreased and slurry stability may be increased even when the slurry is left for a long time, and additionally, volume expansion of the silicon oxide particle during charge and discharge of a battery may be suppressed.

In an example embodiment, residual metal in the silicon oxide particle is removed and damage to the silicon oxide particle and/or the metal silicate may be significantly decreased by treating the silicon oxide particle including the metal silicate which has undergone a metal pre-doping process with an organic acid, specifically a long-chain hydrocarbon organic acid solution, and the hydrocarbon coating layer is provided to prevent further elution of residual metal in the silicon oxide particle, thereby significantly decreasing slurry gas emission even when the slurry is left for a long time and improving slurry stability. In addition, the hydrocarbon coating layer additionally has an effect of suppressing volume expansion of the silicon oxide particle during charge and discharge of a battery.

In an example embodiment, the silicon oxide particle is optionally pre-treated with a general acid solution in order to remove residual metal in the silicon oxide particle before forming the hydrocarbon coating layer, and then the hydrocarbon coating layer is formed on the silicon oxide particle, slurry stability, capacity properties, and initial efficiency may be further improved.

The disclosed technology can be implemented in rechargeable secondary batteries that are widely used in battery-powered devices or systems, including, e.g., digital cameras, mobile phones, notebook computers, hybrid vehicles, electric vehicles, uninterruptible power supplies, battery storage power stations, and others including battery power storage for solar panels, wind power generators and other green tech power generators. Specifically, the disclosed technology can be implemented in some embodiments to provide improved electrochemical devices such as a battery used in various power sources and power supplies, thereby mitigating climate changes in connection with uses of power sources and power supplies. Lithium secondary batteries based on the disclosed technology can be used to address various adverse effects such as air pollution and greenhouse emissions by powering electric vehicles (EVs) as alternatives to vehicles using fossil fuel-based engines and by providing battery-based energy storage systems (ESSs) to store renewable energy such as solar power and wind power.

Although the example embodiments of the disclosed technology have been described above, the disclosed technology is not limited to the example embodiments but may be made in various forms different from each other, and various modifications and changes may be made to the disclosed embodiments and other embodiments may be made based on what is disclosed in this patent document.

What is claimed is:

1. A negative electrode active material for a secondary battery comprising:
a silicon oxide particle including a metal silicate; and
a hydrocarbon coating layer on the silicon oxide particle,
and exhibiting a maximum absorbance peak (Pa) in a spectral range from 2880 cm⁻¹ to 2950 cm⁻¹ from an optical spectral measurement of the optical absorption of the negative electrode active material based on a Fourier transform infrared (FT-IR) spectral analysis of the negative electrode active material and a maximum absorbance peak (Pb) in a range from 2800 cm⁻¹ to 2865 cm⁻¹ in the FT-IR spectral analysis.

2. The negative electrode active material for a secondary battery of claim 1, wherein a ratio (Sb/Sa) between a first peak area value (Sa) in the FT-IR spectral analysis of the negative electrode active material and a second peak area value (Sb) in the FT-IR spectral analysis of the negative electrode active material is 0.7 or less, wherein the second peak area value (Sb) is an area value of an integral of a peak in a wavenumber ranging from 2800 cm⁻¹ to 2865 cm⁻¹ and the first peak area value (Sa) is an area value of an integral of a peak in a wavenumber ranging from 2880 cm⁻¹ to 2950 cm⁻¹.

3. The negative electrode active material of claim 2, wherein the ratio (Sb/Sa) is 0.5 or less.

4. The negative electrode active material of claim 2, wherein the first peak area (Sa) value is 3.0 or less.

5. The negative electrode active material of claim 2, wherein the second peak area (Sb) value is 1.5 or less.

6. The negative electrode active material for a secondary battery of claim 1, wherein peaks Pc1 and Pc2 in the FT-IR spectral analysis of the negative electrode active material are detected in a range from 1520 cm⁻¹ to 1600 cm⁻¹, wherein the peaks Pc1 and Pc2 are derived from a terminal carboxyl group of an oleic acid.

7. The negative electrode active material of claim 1, wherein the metal silicate includes a metal silicate including at least one of lithium (Li), sodium (Na), magnesium (Mg), or potassium (K).

8. The negative electrode active material of claim 7, wherein the metal silicate includes a lithium silicate represented by the following Chemical Formula 1:
LiₓSi_{y}O_{z} [Chemical Formula 1]
wherein 1≤x≤6, 1≤y≤4, and 0<z≤7.

9. The negative electrode active material of claim 1, wherein the hydrocarbon coating layer includes a straight-chain hydrocarbon organic acid having 8 or more carbon atoms or a derivative of the straight-chain hydrocarbon organic acid having 8 or more carbon atoms.

10. The negative electrode active material of claim 9, wherein the straight-chain hydrocarbon organic acid is a fatty acid.

11. A method of producing a negative electrode active material for a secondary battery, the method comprising:
forming a silicon oxide particle including a metal silicate; and
forming a hydrocarbon coating layer on the silicon oxide particle by immersing the silicon oxide particle in an organic acid solution.

12. The method of claim 11, wherein the metal silicate includes a metal silicate including at least one of lithium (Li), sodium (Na), magnesium (Mg), or potassium (K).

13. The method of claim 11, wherein the organic acid solution includes a straight-chain hydrocarbon organic acid having 8 or more carbon atoms.

14. The method of claim 13, wherein the straight-chain hydrocarbon organic acid is a fatty acid.

15. The method of claim 11, wherein forming the hydrocarbon coating layer on the silicon oxide particle includes drying, at 50 to 300° C., the silicon oxide particle immersed in in an organic acid solution.

16. The method of claim 11, wherein forming the hydrocarbon coating layer on the silicon oxide particle by immersing the silicon oxide particle in the organic acid solution includes:
immersing the silicon oxide particle in a first acid solution including an inorganic acid or an organic acid having 6 or fewer carbon atoms to produce a first silicon oxide particle; and
forming the hydrocarbon coating layer by immersing the first silicon oxide particle in an organic acid solution.

17. The method of claim 16, wherein a molar concentration of the first acid solution is in a range from 0.01 to 1.0 molarity (M).

18. A negative electrode for a secondary battery comprising the negative electrode active material of claim 1.

19. The negative electrode of claim 18, further comprising graphite.

20. A secondary battery comprising the negative electrode of claim 18.
